(19) United States
(12) Patent Application Publication
(10) Pub. No.: US 2010/0242544 A1
(43) Pub. Date: Sep. 30, 2010

(54) OPTICAL LENS FORMING MOLD

(75) Inventors: Wen Jen Liao, Taipei County (TW); Tsai Lung Wang, Pingtung County (TW); Wen Hao Chuang, Changhua County (TW); Wen Yu Liang, Taoyuan County (TW); Tzu Yu Lin, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: KINIK COMPANY, Taipei (TW)

(21) Appl. No.: 12/482,755

(22) Filed: Jun. 11, 2009

(30) Foreign Application Priority Data
Mar. 27, 2009 (TW) 098110259

(51) Int. Cl. C03B 23/00

(52) U.S. Cl. 65/286

(57) ABSTRACT

An optical lens forming mold is adapted to press and form a glass preform into an optical lens. The forming mold includes a sleeve, a lower mold core, and an upper mold core. The upper mold core and the lower mold core are disposed within the sleeve opposite to each other, and the glass preform is disposed between the upper mold core and the lower mold core. At least one edge of the upper mold core and the lower mold core is surroundingly arrangement with a baffle. The glass preform is pressed and formed into an optical lens by the upper mold core and the lower mold core, and a shape of the optical lens to be formed is controlled by the battle.

### CROSS-REFERENCE TO RELATED PATENT APPLICATION

This non-provisional application claims priority under 35 U.S.C. §119(a) on Patent Application No(s). 098110259 filed in Taiwan, R.O.C. on Mar. 27, 2009 the entire contents of which are hereby incorporated by reference.

### BACKGROUND OF THE INVENTION

1. Field of the Invention

The present invention relates to a forming mold, and more particularly to a forming mold that uses a sleeve to press and form an optical lens.

2. Related Art

In various different fields, optical elements with optical lenses have been widely used in optical communication devices, optical data reading devices, as well as other types of optical devices.

In a conventional molding method of an optical lens, an optical lens is obtained by pressing and forming a glass preform (optical material) using a forming mold. In general, the forming mold comprises a sleeve, and an upper mold core and a lower mold core in a pair. The lower mold core is positioned within the sleeve to support the glass preform. The upper mold core is disposed within the sleeve in a manner of being movable relative to the lower mold core, and is formed with a mold cavity corresponding to the lower mold core. When the glass preform is placed on the lower mold core and subjected to a high-temperature molding process, by moving the upper mold core towards the lower mold core, the glass preform is pressed and formed within the mold cavity and then deformed into a shape and a thickness of an optical lens expected to be molded, and then subjected to a cooling and shrinking process, so as to form an optical lens. During this process, as the glass preform has rheological properties after being heated, the glass preform is easily affected by the capillary phenomenon or a partial overflow of the glass preform within the mold cavity when being pressed by the upper mold core and the lower mold core. As a result, a portion of the melted glass preform leaks out to abutted surfaces between the sleeve and the upper and lower mold cores, resulting in uneven edge thickness of the formed optical lens.

Moreover, during the cooling and shrinking process at the later stage of the optical lens forming process, as the optical lens and the sleeve shrink at different extents due to different thermal expansion coefficients thereof, an edge of the optical lens in contact with an inner wall of the sleeve is usually absorbed on the inner wall of the sleeve after the optical lens is formed. When an operator puts a sucker into the sleeve to suck the optical lens out of the sleeve, as the edge of the optical lens is absorbed on the inner wall of the sleeve, an edge chipping may occur at the edge of the optical lens after the optical lens is taken out, so that the optical lens becomes defective.

Meanwhile, in order to meet the users' increasingly high pixel requirements in recent years, the development trend for the manufacturing of optical lenses tends to focus on the lighter and thinner optical lenses. However, due to the decreasing of the edge thickness of the optical lens, non-uniform flowing problem easily occurs to the optical lens when being formed during the pressing process using the mold, resulting in a thickness variation; that is, the optical lens is formed with an excessively large thickness at one side, but it is incompletely formed at the other side. What's worse, at the portion where the overflow occurs due to the excessively large thickness, edge chipping of the optical lens is more likely to occur when the optical lens is stripped from the mold, which not only affects the precision of the optical lens, resulting in a reduction of the yield of the optical lens, but also causes that the optical lens cannot be put into mass production.

### SUMMARY OF THE INVENTION

Accordingly, the present invention is an optical lens forming mold, so as to solve the problems in the prior art that due to the poor design of the forming mold, thickness variation and overflow phenomena easily occur because of the non-uniform flowing problem of the optical lens when being formed, which causes uneven thickness of the formed optical lens, thereby reducing the yield of the optical lenses and resulting in difficulties in stripping the optical lens from the mold.

An optical lens forming mold is provided in the present invention, which is adapted to form a glass preform into an optical lens. The forming mold comprises a sleeve, a lower mold core, and an upper mold core. The sleeve has an accommodating space therein. The lower mold core is disposed within the sleeve. The lower mold core has a lower forming surface, and the lower forming surface has a depressed portion for accommodating the glass preform. The upper mold core is disposed within the sleeve in a manner of being movable relative to the lower mold core, and has an upper forming surface. At least one edge of the upper forming surface and the lower forming surface is surroundingly provided with a baffle. The glass preform is formed into an optical lens upon being pressed by the upper forming surface and the lower forming surface, and a shape of the optical lens to be formed is controlled by the baffle.

In the optical lens forming mold of the present invention, by surroundingly providing a baffle on at least one edge of the forming surfaces of the upper mold core and the lower mold core of the forming mold, the shape of the optical lens to be formed is controlled under the guidance of the baffle during the process of pressing the glass preform, so as to avoid the overflow or thickness variation phenomena of the glass preform during the forming process. Therefore, as compared with the prior art, the optical lens forming mold of the present invention can effectively control the shape and thickness of the optical lens to be formed, thus greatly improving the yield and quality in production and assembling processes.

### BRIEF DESCRIPTION OF THE DRAWINGS

The present invention will become more fully understood from the detailed description given herein below for illustration only, and thus is not limitative of the present invention, and wherein:

FIG. 1 is a schematic view of operations of an optical lens forming mold according to the present invention;

FIG. 2 is a schematic view of a forming operation of the optical lens forming mold according to the present invention;

FIG. 3 is a schematic view of an optical lens formed according to the present invention; and

FIGS. 4-9 are schematic structural views of forming molds according to different embodiments of the present invention.

### DETAILED DESCRIPTION OF THE INVENTION

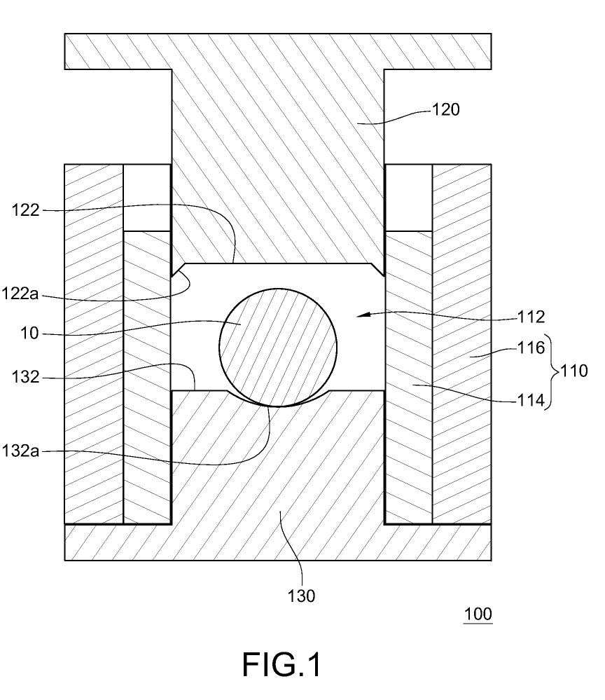

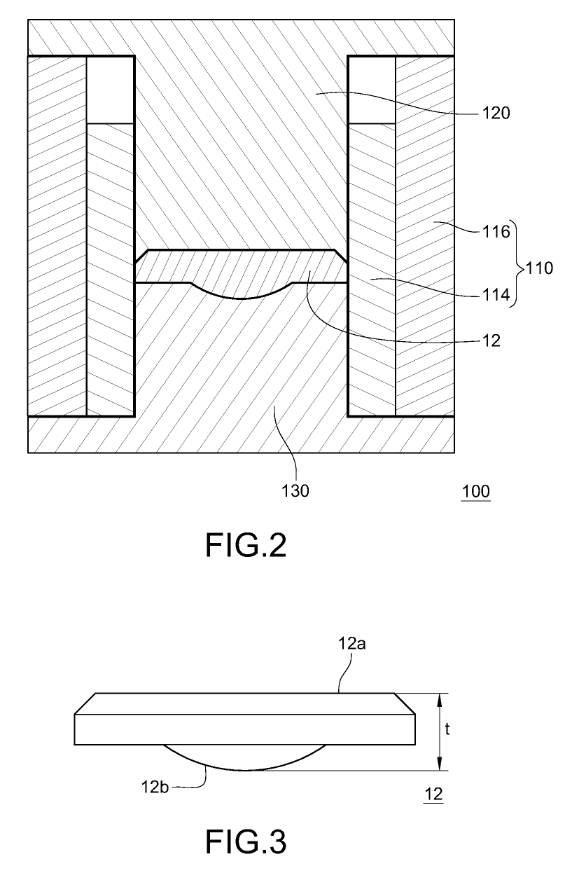

FIG. 1 is a schematic view of operations of an optical lens forming mold according to the present invention. FIG. 2 is a schematic view of a forming operation of the optical lens forming mold according to the present invention. FIG. 3 is a schematic view of an optical lens formed according to the present invention.

Referring to FIGS. 1 and 2, an optical lens forming mold 100 in an embodiment of the present invention is adapted to form a glass preform 10 into an optical lens 12. The optical lens provided in the embodiment of the present invention is applicable to laser diodes, photodiodes, optic fibers, digital cameras, mobile phones, compact disk (CD) players, and other optical devices. In the detailed description of the present invention below, a mobile phone is taken as one embodiment of the present invention. However, the accompanying drawings are merely given for the purpose of making reference and illustrations, but not intended to limit the scope of the present invention.

Referring to FIG. 1, the forming mold 100 in this embodiment of the present invention comprises a sleeve 110, an upper mold core 120, and a lower mold core 130. The sleeve 110 has an accommodating space 112 therein. The upper mold core 120 and the lower mold core 130 are disposed within the sleeve. The sleeve 110 has an inner sleeve 114 and an outer sleeve 116. The inner sleeve 114 wraps around two sides of the upper mold core 120 and the lower mold core 130, and the outer sleeve 116 is disposed on an outer side of the inner sleeve 114. The upper mold core 120 and the lower mold core 130 are configured in a cylindrical form, and the upper mold core 120 is movable relative to the lower mold core 130. One side of the lower mold core 130 bears against the outer sleeve 116. An upper forming surface 122 and a lower forming surface 132 are respectively provided on two opposite side surfaces between the upper mold core 120 and the lower mold core 130, and the lower forming surface 132 has a depressed portion 132a for accommodating the glass preform 10. An edge of the upper forming surface 122 is surroundingly provided with a baffle 122a. In this embodiment, the baffle 122a is disposed on an edge of the upper forming surface 122, but is not limited thereto. Alternatively, the baffle 122a may be disposed on an edge of the lower forming surface 132, or the baffle 122a may be disposed on the edges of both the upper forming surface 122 and the lower forming surface 132.

Moreover, an inner diameter of the inner sleeve 114 corresponds to a diameter of the upper mold core 120 and the lower mold core 130 of the forming mold 100. The inner sleeve 114 is disposed to fix the upper mold core 120 and the lower mold core 130, so as to enable the upper mold core 120 and the lower mold core 130 to slide within the inner sleeve 114, and the outer sleeve 116 is disposed to control the thickness of forming the glass preform 10. Referring to FIG. 2, when the forming mold 100 is operated to form the optical lens 12, the upper mold core 120 moves within the inner sleeve 114 relative to the lower mold core 130, and stops moving when one side of the upper mold core 120 bears against one side of the outer sleeve 116. At this time, a distance between the upper mold core 120 and the lower mold core 130 is just a thickness t of the optical lens 12 (as shown in FIG. 3). Accordingly, in terms of the design of the forming mold 100, the thickness t of the optical lens 12 can be changed by simply changing the height of the outer sleeve 116, so the thickness t of the optical lens 12 can be controlled by the outer sleeve 116.

Referring to FIGS. 1, 2, and 3 continuously, the motions of the forming mold 100 are described below. The glass preform 10 is placed in the accommodating space 112 and placed at the depressed portion 132a of the lower forming surface 132 of the lower mold core 130 (as shown in FIG. 1), and a heater (not shown) is used to heat the forming mold 100 to provide a heat source to the forming mold 100 and the glass preform 10, so as to heat and soften the glass preform 10. After the glass preform 10 is softened, the upper mold core 120 and the lower mold core 130 press the glass preform 10 through the upper forming surface 122 and the lower forming surface 132 respectively (as shown in FIG. 2). The softened glass preform 10 is pressed to flow and is deformed into a shape corresponding to the upper forming surface 122 and the lower forming surface 132, and is embedded within the sleeve 110, and formed into an optical lens 12 having a thickness t according to the distance between the upper mold core 120 and the lower mold core 130 (as shown in FIG. 3).

During the process of forming the optical lens 12, the glass preform 10 is softened and flows within the inner sleeve 114, and pressed by the upper forming surface 122 and the lower forming surface 132, so as to be deformed corresponding to the shape of the upper forming surface 122 and the lower forming surface 132. Particularly, as the baffle 122a is surroundingly provided on an edge of the upper forming surface 122, the shape and thickness t of the glass preform 10 may be varied according to the pressing motion of the upper forming surface 122 and the lower forming surface 132 and according to the shape of the baffle 122a, and the glass preform 10 is restricted and closely attached between the inner sleeve 114 and the upper and lower forming surfaces 122 and 132. In such a manner, the glass preform 10 is formed into the optical lens 12 upon being pressed by the upper forming surface 122 and the lower forming surface 132, and the shape and the thickness t of the optical lens 12 to be formed are controlled by the shape of the baffle 122a, such that the optical lens 12 embedded with the upper mold core 120 and the lower mold core 130 (as shown in FIG. 3) is formed.

As known from the above, when it intends to form the optical lens 12 through the pressing motion, the baffle 122a can prevent the overflowing phenomenon, and by using the shape of the periphery of the formed optical lens 12, the thickness t of each formed optical lens 12 is maintained at a steady value.

By controlling the shape of the optical lens 12 to be formed, uneven thickness and overflowing phenomena of the glass preform 10 during the pressing process can be avoided, thus improving the yield and quality of the optical lens 12 in production and assembling processes.

In addition, the optical lens 12 has a first surface 12a and a second surface 12b. The first surface 12a corresponds to the upper forming surface 122, and the second surface 12b corresponds to the lower forming surface 132. In this embodiment, the upper forming surface 122 is a plane. Therefore, the first surface 12a of the optical lens 12 formed by the forming mold 100 is a plane, and the second surface 12b of the optical lens 12 is a convex surface. The shape of the formed optical lens 12 is determined depending on the shape of the forming mold 100. In this embodiment, the baffle 122a is integrally formed with an edge of the upper forming surface 122, and the baffle 122a may alternatively be attached or assembled to the edge of the upper forming surface 122, but not limited thereto. The sleeve 110 is a hollow cylinder formed by cutting, punching, or casting a metal such as aluminum, stainless steel, or tungsten carbide, and is used to hold the optical lens 12.

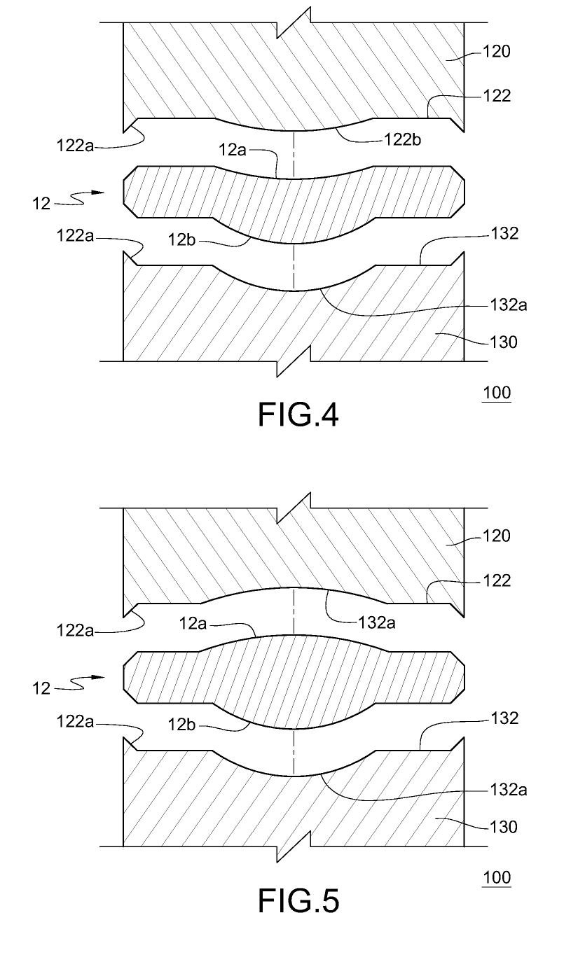

FIGS. 4-9 are schematic structural views of forming molds according to different embodiments of the present invention. The embodiments of the present invention comprise an optical lens 12, an upper mold core 120, and a lower mold core 130. The upper mold core 120 has an upper forming surface 122, and the lower mold core 130 has a lower forming surface 132 corresponding to the upper forming surface 122. An edge of the upper forming surface 122 and that of the corresponding lower forming surface 132 are both surroundingly provided with a baffle 122a. The optical lens 12 is made of a glass material and is embedded between the upper mold core 120 and the lower mold core 130, and has a first surface 12a and a second surface 12b.

As shown in FIG. 4, the upper forming surface 122 has a protruded portion 122b corresponding to the depressed portion 132a of the lower mold core 130. In this manner, the first surface 12a of the optical lens 12 formed by such a forming mold is a concave surface, and the second surface 12b of the optical lens 12 is a convex surface. As shown in FIG. 5, the upper forming surface 122 has a depressed portion 132a at a central position thereof corresponding to the depressed portion 132a of the lower mold core 130. In this manner, the first surface 12a and the second surface 12b of the optical lens 12 formed by such a forming mold are both convex surfaces. As known from the above descriptions that, the configurations of the first surface 12a and the second surface 12b (such as a single-convex lens, a concave-convex lens, or a double-convex lens) are determined depending upon the shapes of the upper forming surface 122 and the lower forming surface 132 of the forming mold during the manufacturing process.

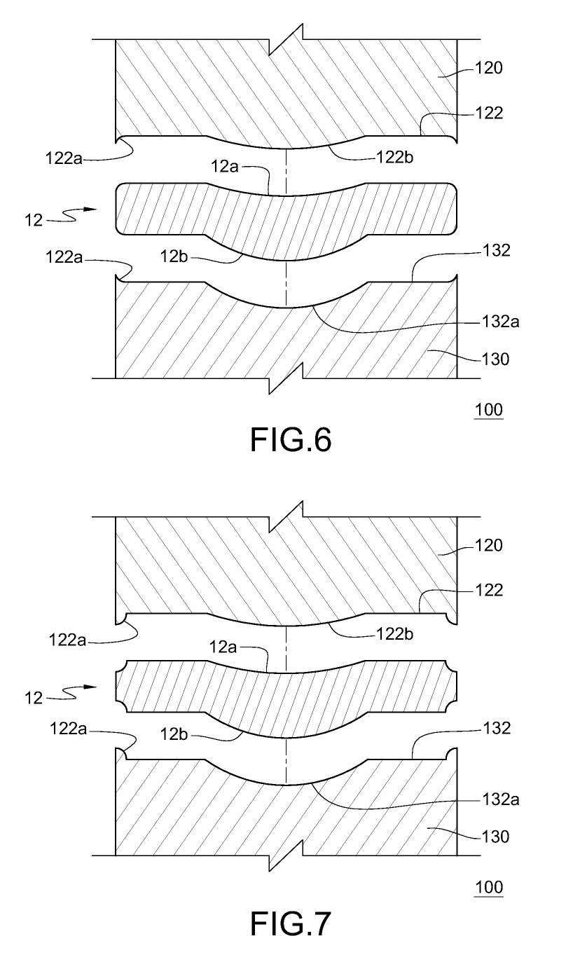

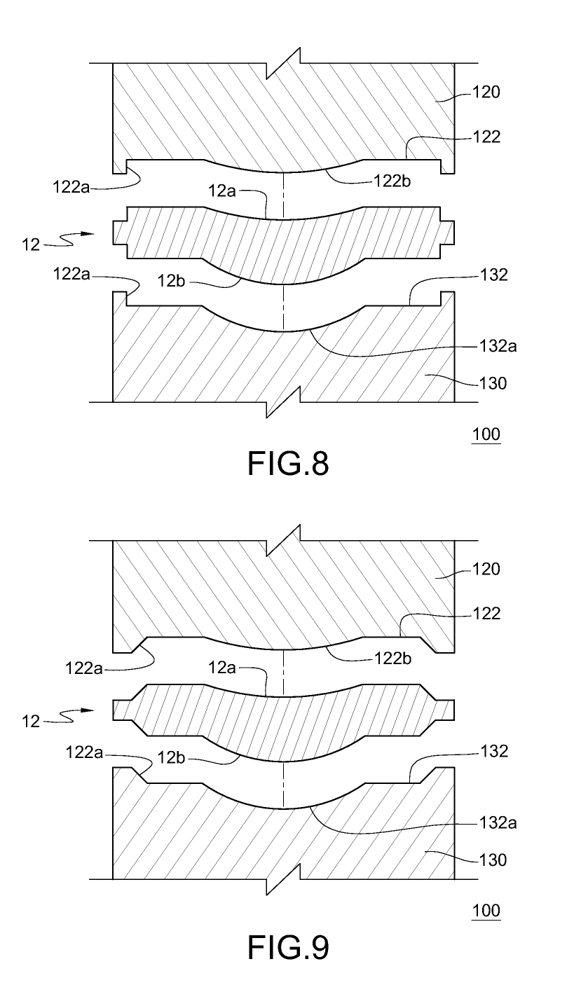

The baffle 122a is disposed to control the shape of the optical lens 12 to be formed, and the shape of the baffle 122a may be varied according to the shape of the forming mold 100. Therefore, as shown in FIGS. 4 and 5, the baffle 122a is a bevel structure, and a periphery position of the optical lens 12 corresponding to the baffle 122a is a bevel. As shown in FIGS. 6 and 7, the baffle 122a is a camber structure, for example, a concave camber (as shown in FIG. 6), and the periphery position of the optical lens 12 corresponding to the baffle 122a is a convex camber. Alternatively, as shown in FIG. 7, the baffle 122a is a convex camber, and the periphery position of the optical lens 12 corresponding to the baffle 122a is a concave camber. Referring to FIGS. 8 and 9, the baffle 122a may also be a steplike structure, for example, a right-angle steplike structure as shown in FIG. 8 or an oblique-angle steplike structure as shown in FIG. 9, and in this case, the periphery position of the optical lens 12 corresponding to the baffle 122a is in a shape of a corresponding concave step. As described above, the profile of the optical lens 12 can be changed according to the shape of the baffle 122a in the embodiments of the present invention, and the optical lens 12 formed by hot pressing has an even thickness. Moreover, as a contact area between the periphery of the optical lens 12 and the inner sleeve 114 (shown in FIG. 2) is reduced, the optical lens 12 can be easily stripped from the mold when the mold is removed, and thus no edge chipping occurs. To sum up, in the optical lens forming mold of the present invention, at least one edge of the upper mold core and the lower mold core is provided with a baffle to control the shape and the thickness of the optical lens to be formed, so as to avoid the overflowing or thickness variation phenomena of the glass preform due to the non-uniform flowing problem during the forming process, thereby greatly improving the yield and quality of the optical lens in production and assembling processes.

What is claimed is:

1. An optical lens forming mold, adapted to form a glass preform into an optical lens, the forming mold comprising:
a sleeve, having an accommodating space therein;
a lower mold core, disposed within the sleeve, wherein the lower mold core has a lower forming surface, and the lower forming surface has a depressed portion for accommodating the glass preform; and
an upper mold core, disposed within the sleeve in a manner of being movable relative to the lower mold core, wherein the upper mold core has an upper forming surface;
wherein at least one edge of the upper forming surface and the lower forming surface is surroundingly provided with a baffle, the glass preform is formed into an optical lens upon being pressed by the upper forming surface and the lower forming surface, and a shape of the optical lens to be formed is controlled by the baffle.

2. The optical lens forming mold according to claim 1, wherein the baffle is a bevel structure.

3. The optical lens forming mold according to claim 1, wherein the baffle is a camber structure.

4. The optical lens forming mold according to claim 1, wherein the baffle is a steplike structure.

5. The optical lens forming mold according to claim 1, wherein the baffle is a oblique-angle steplike.

6. The optical lens forming mold according to claim 1, wherein the upper forming surface is a plane.

7. The optical lens forming mold according to claim 1, wherein the upper forming surface has a protruded portion corresponding to the depressed portion of the lower mold core.

8. The optical lens forming mold according to claim 1, wherein the upper forming surface has a depressed portion at a central position thereof corresponding to the depressed portion of the lower mold core.

9. The optical lens forming mold according to claim 1, wherein the baffle is integrally formed with at least one edge of the upper forming surface and the lower forming surface.

10. The optical lens forming mold according to claim 1, wherein the sleeve has an outer sleeve and an inner sleeve, an inner diameter of the inner sleeve corresponds to a diameter of the upper mold core and the lower mold core, and the outer sleeve is disposed at a periphery of the inner sleeve.
